(19) United States
(12) Patent Application Publication
(10) Pub. No.: US 2026/0204975 A1
(43) Pub. Date: Jul. 16, 2026

(54) MOTOR

(71) Applicant: KOMATSU LTD., Tokyo (JP)

(72) Inventors: Yuki Ishii, Tokyo (JP); Hiroki Hijikata, Tokyo (JP)

(73) Assignee: KOMATSU LTD., Tokyo (JP)

(21) Appl. No.: 19/136,477

(22) PCT Filed: Jan. 24, 2024
(86) PCT No.: PCT/JP2024/002028

§ 371 Date: Jun. 6, 2025

(30) Foreign Application Priority Data
Jan. 26, 2023 (JP) 2023-010343

(51) Int. Cl. H02K 3/52

(52) U.S. Cl. CPC H02K 3/522

(57) ABSTRACT

A motor includes a stator core, a plurality of slots disposed in a circumferential direction of the stator core, a coil disposed in the slots, a connecting wire connecting a plurality of coils, and an insulating paper configured to insulate a coil end portion of the coil from the connecting wire at the coil end portion. The connecting wire is formed with a larger surface area at a portion located on the insulating paper than other portions.

### TECHNICAL FIELD

The present disclosure relates to a motor.

### BACKGROUND ART

For a stator of a rotary electric machine, a technique to have a bonding strength of a connecting wire and reduce vibration of the connecting wire is known (see, for example, Patent Document 1). In the technique described in Patent Document 1, a flexible fixing member that flexibly fixes the connecting wire and an insulator is disposed.

### CITATION LIST

### Patent Literature

Patent Document 1: JP 2015-089162 A

### SUMMARY OF INVENTION

### Technical Problem

In the technique described in Patent Document 1, the flexible fixing member is disposed at every slot, thus increasing the number of components and also increasing the number of assembling steps.

An object of the present disclosure is to provide a motor in which an increase in the number of components is suppressed and vibration of a connecting wire is reduced.

### Solution to Problem

The present disclosure provides a motor including: a stator core; a plurality of slots disposed in a circumferential direction of the stator core; a coil disposed in the slots; a connecting wire connecting a plurality of the coils; and an insulating member configured to insulate a coil end portion of the coil from the connecting wire at the coil end portion. The connecting wire is formed with a larger surface area at a portion located on the insulating member than at other portions.

### Advantageous Effects of Invention

The present disclosure provides a motor in which an increase in the number of components is suppressed and vibration of a connecting wire is reduced.

### BRIEF DESCRIPTION OF DRAWINGS

FIG. 1 is a diagram schematically illustrating a motor according to a first embodiment.

FIG. 2 is a plan view illustrating a stator core and coils according to the first embodiment.

FIG. 3 is a partially enlarged view of FIG. 2.

FIG. 4 is a schematic view schematically illustrating a coil end portion.

FIG. 5 is a schematic view schematically illustrating a coil end portion.

FIG. 6 is a cross-sectional view of FIG. 5.

FIG. 7 is a schematic view schematically illustrating a coil end portion.

### DESCRIPTION OF EMBODIMENTS

Hereinafter, embodiments of the disclosure will be described with reference to the drawings, but the invention is not limited to the embodiments. The components of the embodiments described below can be combined as appropriate. In addition, some components are not used in some cases.

### Embodiment

### Motor

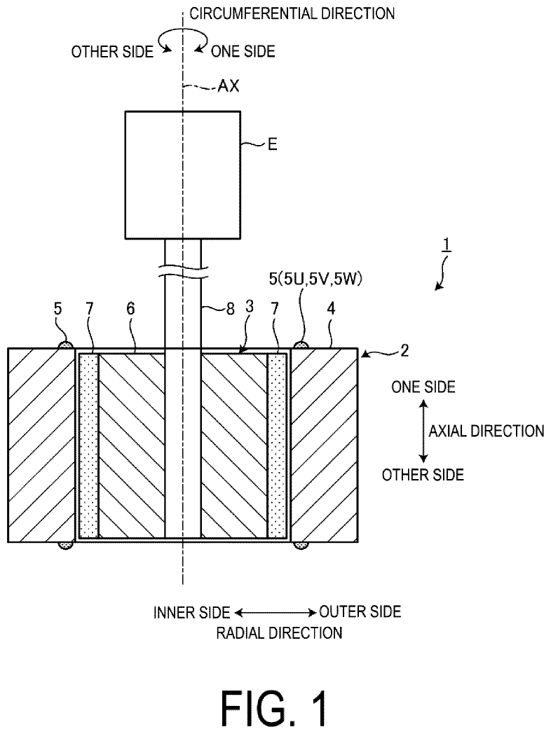

FIG. 1 is a diagram schematically illustrating a motor 1 according to an embodiment. In the embodiment, the motor 1 is a three-phase switched reluctance motor. The motor 1 includes a stator 2 having a cylindrical shape and a rotor 3 disposed on an inner side of the stator 2. The stator 2 includes a stator core 4 having a cylindrical shape and a coil 5 supported by the stator core 4. The inner circumferential surface of the stator 2 and the outer circumferential surface of the rotor 3 face each other with a gap therebetween. The rotor 3 faces the stator core 4. The rotor 3 rotates about a rotation axis AX. The rotation axis AX of the rotor 3 and the central axis of the stator 2 are identical. The rotor 3 is connected to an object E via a shaft 8. The object E is, for example, an engine mounted on a hybrid excavator which is a type of construction machine. The motor 1 functions as a generator driven by the engine.

In the following description, a direction parallel to the rotation axis AX is referred to as an axial direction. One side in the axial direction is referred to as one axial side, and a side opposite to the one axial side is referred to as the other axial side. A direction going around the rotation axis AX is referred to as a circumferential direction. One side in the rotation direction in the circumferential direction is referred to as one circumferential side, and a side opposite to the one circumferential side is referred to as the other circumferential side. A radiation direction of the rotation axis AX is referred to as a radial direction. A side in a direction away from the central axis AX in the radial direction is referred to as a radial outer side, and a side opposite to the radial outer side is referred to as a radial inner side.

The rotor 3 is disposed to be able to face the stator core 4. The rotor 3 includes a rotor holder 6 and a rotor core 7 held by the rotor holder 6. The rotor holder 6 is made of a non-magnetic material. The rotor core 7 is made of a magnetic material.

The stator core 4 includes a slot 9 for accommodating the coil 5. The slot 9 is a recessed portion recessed toward the radial outer side from the inner circumferential surface of the stator core 4. A plurality of the slots 9 are arranged in the circumferential direction at the inner circumferential surface of the stator core 4. The slots 9 extend in the axial direction. The slots 9 are disposed at the inner circumferential surface of the stator core 4. The slots 9 are open toward the one axial side, the other axial side, and the radial inner side.

The stator core 4 includes a plurality of teeth 10 disposed between the slots 9 adjacent to each other in the circumferential direction. The teeth 10 are portions of the stator core 4 around which the coil 5 is wound. The teeth 10 support the coil 5. The teeth 10 are inserted into opening of the coil 5.

### Coils

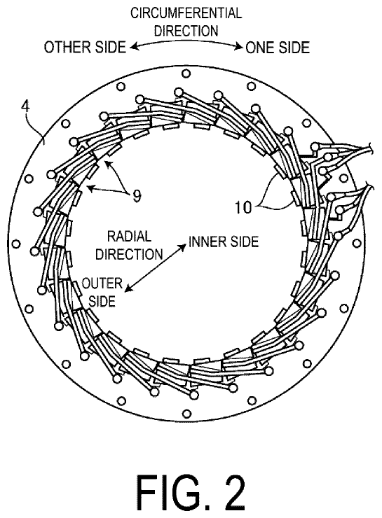

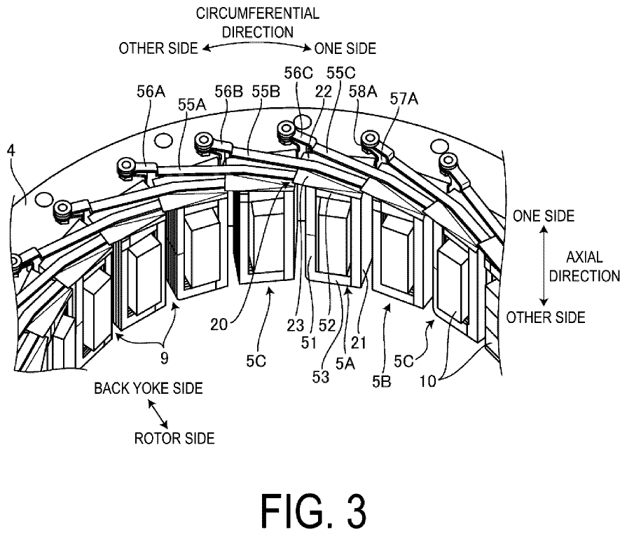

FIG. 2 is a plan view illustrating the stator core and the coils according to a first embodiment. FIG. 3 is a partially enlarged view of FIG. 2.

The coil 5 is disposed around the teeth 10. The coil 5 is supported by the teeth 10. The coil 5 includes an opening. The teeth 10 are inserted into the opening of the coil 5.

The coil 5 includes a coil body portion 51, a coil end portion 52, and a coil end portion 53. A portion of the coil 5 accommodated in the slot 10 is the coil body portion 51. A portion of the coil 5 protruding from the stator core 4 toward the one axial side is the coil end portion 52. A portion of the coil 5 protruding from the stator core 4 toward the other axial side is the coil end portion 53.

A portion extending from the coil end portion 52 toward the other circumferential side is a connecting wire 55. The connecting wire 55 is drawn out from a rotor side of the coil end portion 52. The connecting wire 55 is disposed toward a back yoke side as it approaches a terminal portion 56. The connecting wire 55 is located on the one axial side of the coil end portion 52. The connecting wire 55 has a length reaching a terminal portion 58 of a connection target coil 5 having the same phase located adjacent in the circumferential direction. The terminal portion 56 is connected to the terminal portion 58 of the connection target coil 5. The terminal portion 56 is disposed at a leading end portion of the connecting wire 55.

A portion extending from the coil end portion 52 toward the one circumferential side is a connecting wire 57. The connecting wire 57 is drawn out from the back yoke side of the coil end portion 52. The terminal portion 58 is disposed at a leading end portion of the connecting wire 57. The connecting wire 57 is located on the one axial side of the coil end portion 52.

The coil 5 is formed of, for example, a linear or strip-shaped conductor such as a rectangular wire, a round wire, or a plate-shaped segment conductor. The coil 5 is formed of a conductor disposed in a spiral shape. The coil 5 may be formed by winding a single conductor in a spiral shape, or may be formed by connecting a plurality of conductors in a spiral shape. A winding method and a connection method of the coil 5 are not limited.

The coil 5 is disposed in the slots 9 by concentrated winding. The coil 5 is partially accommodated in the slots 9 and supported by the teeth 10.

The coil 5 includes an A-phase coil (first phase coil) 5A, a B-phase coil (second phase coil) 5B, and a C-phase coil (third phase coil) 5C. The A-phase coil 5A, the B-phase coil 5B, and the C-phase coil 5C are each denoted as the coil 5 when not needing to be distinguished from each other.

The A-phase coil 5A and the B-phase coil 5B are adjacent to each other in the circumferential direction. The B-phase coil 5B and the C-phase coil 5C are adjacent to each other in the circumferential direction. The C-phase coil 5C and the A-phase coil 5A are adjacent to each other in the circumferential direction. The B-phase coil 5B is disposed adjacent to the A-phase coil 5A on the one circumferential side. The C-phase coil 5C is disposed adjacent to the B-phase coil 5B on the one circumferential side. The A-phase coil 5A is disposed adjacent to the C-phase coil 5C on the one circumferential side.

The connecting wire 55 is disposed on an insulating paper 20 which is an example of the insulating member. The insulating member may be, for example, a resin plate. The insulating member may be, for example, a coil end 52 including an insulating film.

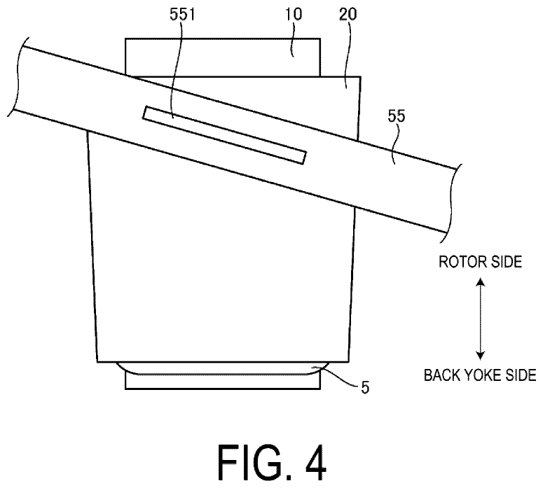

FIG. 4 is a schematic view schematically illustrating a coil end portion. The connecting wire 55 is formed with a hole portion 551 at a portion located on the insulating paper 20. The hole portion 551 illustrated in FIG. 4 is an elongated hole whose longitudinal direction is arranged along a direction in which the connecting wire 55 extends. The hole portion 551 is not limited to an elongated hole. The hole portion 551 may have any shape such as a round hole or a rectangular hole. The number of hole portions 551 is not limited. The hole portion 551 may be formed by a plurality of round holes, for example. In the connecting wire 55 illustrated in FIG. 4, the hole portion 551 is impregnated with a fluid fixing material such as varnish. This allows the connecting wire 55 to be fixed to the insulating paper 20 by the varnish.

The insulating paper 20 is made of a sheet-like material having an electrical insulation property. The insulating paper 20 insulates the coil 5. More specifically, the insulating paper 20 insulates the coil body portion 5 from another coil 5 adjacent thereto in the circumferential direction. The insulating paper 20 insulates the coil end portion 52 of the coil 5 from the connecting wire 55 of a phase different from the coil end portion 52. In the embodiment, the shape of the insulating paper 20 is not limited.

### Actions

Insulation of the coil 5 by the insulating paper 20 will be described. The tooth 10 supporting the B-phase coil 5B is located adjacent to the tooth 10 supporting the A-phase coil 5A on the other side in the circumferential direction. The tooth 10 supporting the C-phase coil 5C is located adjacent to the tooth 10 supporting the B-phase coil 5B on the other side in the circumferential direction. In this way, the A-phase coil 5A, the B-phase coil 5B, and the C-phase coil 5C are sequentially arranged in the circumferential direction. Here, the A-phase coil 5A will be described as an example, but the B-phase coil 5B and the C-phase coil 5C are also insulated in substantially the same manner.

As an example, the tooth 10 supporting the A-phase coil 5A will be described. A connecting wire 55A of the A-phase coil 5A and a connecting wire 55B of the B-phase coil 5B are insulated from each other by a bent portion 24 of the insulating paper 20. The connecting wire 55B of the B-phase coil 5B and a connecting wire 55C of the C-phase coil 5C are insulated from each other by being spaced apart from each other in the radial direction. A coil end portion 52A of the A-phase coil 5A is insulated from the connecting wire 55B of the B-phase coil 5B and the connecting wire 55C of the C-phase coil 5C by a wall portion 22 of the insulating paper 20.

### Effects

As described above, in the embodiment, the connecting wire 55 of the coil 5 is formed with a larger surface area at the portion located on the insulating paper 20 than at other portions. The embodiment can increase, in fixing the insulating paper 20 to the connecting wire 55 by varnish or the like, the contact area between the connecting wire 55 and the varnish. The embodiment can more firmly fix the connecting wire 55 to the insulating paper 20. This allows the present embodiment to reduce the vibration of the connecting wire 55. The present embodiment allows an increase in the number of components to be suppressed and allows the vibration of the connecting wire 55 to be reduced. A member to which the connecting wire 55 is fixed is not limited to the insulating paper 20 as in the embodiment but may be another member, for example, the coil end 52 including an insulating film.

In the embodiment, the connecting wire 55 of the coil 5 is formed with a larger surface area at the portion located on the insulating paper 20 than at other portions. The embodiment provides a portion that is easily fixed to the insulating paper 20 in the middle of the connecting wire 55 in the longitudinal direction. The embodiment allows a portion of the connecting wire 55 serving as an antinode of vibration to be easily fixed to the insulating paper 20.

In the embodiment, the connecting wire 55 of the coil 5 includes the hole portion 551 at a portion located on the insulating paper 20. The embodiment allows, in fixing the insulating paper 20 to the connecting wire 55 by varnish or the like, the varnish or the like to enter the hole portion 551, allowing the connecting wire 55 to be more firmly fixed to the insulating paper 20.

### First Modification

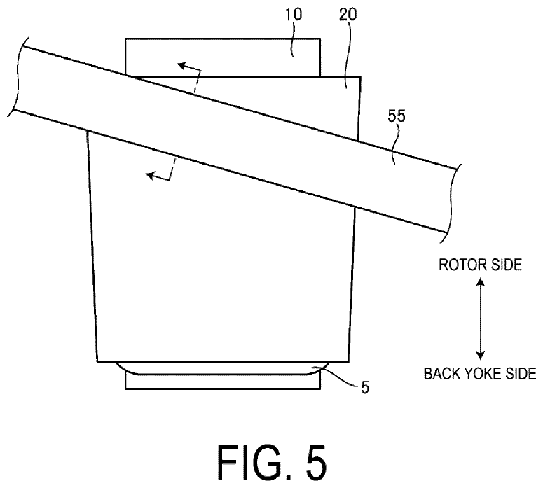

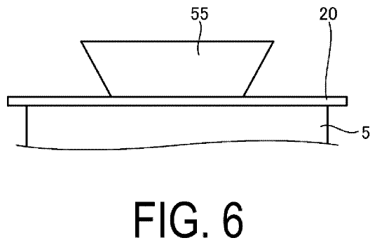

FIG. 5 is a schematic view schematically illustrating a coil end portion. FIG. 6 is a cross-sectional view of FIG. 5. The connecting wire 55 illustrated in FIG. 5 has a trapezoidal cross section in the axial direction. In the trapezoidal cross-sectional shape, a side in contact with the insulating paper 20 is a short side, and a side separated from the insulating paper 20 is a long side. In the shapes illustrated in FIGS. 5 and 6, varnish or the like is impregnated between the long side and the short side. This allows the connecting wire 55 to be fixed to the insulating paper 20 by the varnish. The vibration of the connecting wire 55 is reduced.

### Effects

In the modification, the connecting wire 55 of the coil 5 is formed with the cross section in the axial direction being smaller toward the insulating paper at the portion located on the insulating paper 20. The embodiment allows, in fixing the insulating paper 20 to the connecting wire 55 by varnish or the like, the varnish or the like to enter between side surfaces of the connecting wire 55 and the insulating paper 20, allowing the connecting wire 55 to be more firmly fixed to the insulating paper 20.

### Second Modification

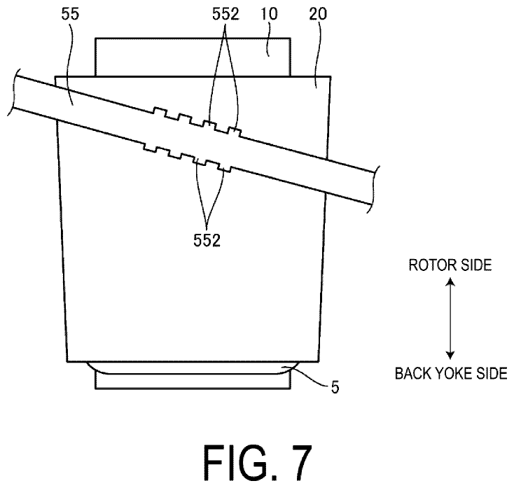

FIG. 7 is a schematic view schematically illustrating a coil end portion. The connecting wire 55 illustrated in FIG. 7 includes irregularities formed at end portions of the connecting wire 55 in the width direction. In the example illustrated in FIG. 7, the connecting wire 55 includes protrusions 552 disposed at intervals along the longitudinal direction. In the example illustrated in FIG. 7, varnish or the like is impregnated into recesses between the protrusions 552. This allows the connecting wire 55 to be fixed to the insulating paper 20 by the varnish. The vibration of the connecting wire 55 is reduced.

### Effects

In the modification, the connecting wire 55 of the coil 5 is formed with the protrusions 552 at end portions in the width direction in the portion located on the insulating paper 20. The embodiment allows, in fixing the insulating paper 20 to the connecting wire 55 by varnish or the like, the varnish or the like to enter the irregularities of side surfaces of the connecting wire 55, allowing the connecting wire 55 to be more firmly fixed to the insulating paper 20.

In the above-described embodiment, the rotor 3 is disposed on the inner side (inner circumferential side) of the stator core 4, and the motor 1 is an inner rotor motor. The rotor 3 is disposed at a position facing the stator core 4. The motor 1 may be an outer rotor motor in which the rotor 3 is disposed on the outer circumferential side of the stator core 4, a dual rotor motor in which the rotor 3 is disposed on both the inner circumferential side and the outer circumferential side of the stator core 4, or an axial gap motor in which the rotor 3 is disposed on an axial direction side of the stator core 4.

### Third Modification

In the modification, the connecting wire 55 of the coil 5 includes surface irregularities formed by a physical or chemical surface treatment at a portion located on the insulating paper 20, and the portion has a larger surface area than other portions. For example, a surface treatment such as a blast treatment is performed only on the connecting wire part 55 or only on a part of the connecting wire part 55 that is in contact with the insulating paper 20.

### Effects

In the modification, the modification can increase a fixing force.

In the above-described embodiment, the motor 1 is a switched reluctance motor. The motor 1 may be a synchronous reluctance motor, a flux switching motor, a permanent magnet motor, an induction motor, an axial gap motor, or a linear actuator.

### REFERENCE SIGNS LIST

1 Motor; 2 Stator; 3 Rotor; 4 Stator core; 5 Coil; 5A A-phase coil; 5B B-phase coil; 5C C-phase coil; 5U U-phase coil (first phase coil); 5V V-phase coil (second phase coil); 5W W-phase coil (third phase coil); 6 Rotor holder; 7 Rotor core; 8 Shaft; 9 Slot; 10 Tooth; 20 Insulating paper (insulating member); Opening; 51 Coil body portion; 52 Coil end portion; 53 Coil end portion; 55 Connecting wire; 56 Terminal portion; 57 Connecting wire; 58 Terminal portion; AX Rotation axis; E Object.

1. A motor, comprising:
a stator core;
a plurality of slots disposed in a circumferential direction of the stator core;
a coil disposed in the slots;
a connecting wire connecting a plurality of the coils; and
an insulating member configured to insulate a coil end portion of the coil from the connecting wire at the coil end portion, wherein
the connecting wire is formed with a larger surface area at a portion located on the insulating member than at other portions.

2. The motor according to claim 1, wherein the connecting wire comprises a hole portion at the portion located on the insulating member.

3. The motor according to claim 1, wherein the connecting wire is formed with a cross section in an axial direction being smaller toward the insulating member at the portion located on the insulating member.

4. The motor according to claim 1, wherein the connecting wire comprises irregularities formed at end portions in a width direction at the portion located on the insulating member.

5. The motor according to claim 1, wherein the connecting wire includes surface irregularities formed by a physical or chemical treatment at the portion located on the insulating member.
